(19) United States
(12) Patent Application Publication
(10) Pub. No.: US 2018/0310176 A1
(43) Pub. Date: Oct. 25, 2018

(54) Methods and Systems For Authenticating a Device to a Wireless Network

(71) Applicants: Mai Abdelhakim, McDonald, PA (US); Christian Breuer, Dortmund (DE); Sergio Bermudez, Boston, MA (US)

(72) Inventors: Mai Abdelhakim, McDonald, PA (US); Christian Breuer, Dortmund (DE); Sergio Bermudez, Boston, MA (US)

(73) Assignee: OSRAM SYLVANIA Inc., Wilmington, MA (US)

(21) Appl. No.: 15/494,751

(22) Filed: Apr. 24, 2017

(51) Int. Cl. H04W 12/08; H04W 76/02; H04W 4/02; H04L 29/08; H04W 12/06; H04L 29/06; H04W 12/04; H04L 9/08; H04L 9/32; H04W 12/02; H04W 12/10

(52) U.S. Cl. CPC H04W 12/08; H04W 76/02; H04W 4/02; H04L 67/12; H04W 12/06; H04L 63/104; H04L 2209/80; H04L 63/0428; H04L 9/0819; H04L 9/3236; H04W 12/02; H04W 12/10; G06F 2221/2111; H04W 12/04

(57) ABSTRACT

Aspects of the present disclosure include methods and systems for commissioning and authenticating devices for joining a local network that improve the security of the network and make it more difficult for unauthorized devices to gain access to the network. In some examples, communication channels that have a more limited range and direction as compared to radio frequency communication are employed for exchanging information to join the network, such as cryptographic keys. The communication channels may include acoustic or optical channels. In some examples, techniques for deriving temporary and/or dynamic keys are disclosed.

### FIELD OF THE DISCLOSURE

The present disclosure generally relates to the field of wireless networks. In particular, the present disclosure is directed to methods and systems for authenticating a device to a wireless network.

### BACKGROUND

Today, typical wireless networks use the radio frequency (RF) medium to exchange authentication messages, and typically rely on static or fixed keys for device authentication, data authentication, integrity check, and encryption. The nature of the RF medium, however, including the ability to penetrate walls, can make such a network vulnerable to various security threats. For example, devices outside of the local network may still gain access to the network if they are within its communication range. An attacker could claim the identity of an indoor device or sniff traffic to learn secret information, such as network or link keys. With the wide deployment of Internet of Things (IoT) this problem must be resolved to avoid critical consequences, such as hackers gaining control over IoT devices in private homes, businesses, banks, etc.

### SUMMARY OF THE DISCLOSURE

In one implementation, the present disclosure is directed to a method of commissioning an indoor device with a commissioning device for adding the indoor device to a wireless network. The method includes receiving, at the indoor device, an optical or acoustic signal from the commissioning device, in which the optical or acoustic signal contains a first message; and using, by the indoor device, information in the first message to join the wireless network.

In yet another implementation, the present disclosure is directed to an indoor device that includes an RF communications module for communication over a wireless network; and at least one of an optical or acoustic communications module for receiving an optical or acoustic signal from a commissioning device, the optical or acoustic signal including information for joining the wireless network, the information including a first key.

In yet another implementation, the present disclosure is directed to a system that includes one or more indoor devices, a commissioning device, and an access point. The commissioning device is configured to transmit a first message to one or more indoor devices through an optical or acoustic signal, the first message including a first key. Each indoor device is configured to receive the first message via an optical or acoustic transceiver, derive a second key from the first key, the second key used to authenticate the indoor device with a wireless network, transmit the second key to an access point of the wireless network, and transmit the first key to a mobile device requesting access to the wireless network via an optical or acoustic signal. The access point is configured to provide the first key to the commissioning device, authenticate the one or more indoor devices to the wireless network upon receipt of the second key from each of the one or more indoor devices, and authenticate the mobile device to the wireless network upon receipt of the second key from the mobile device.

### BRIEF DESCRIPTION OF THE DRAWINGS

For the purpose of illustrating various embodiments, the drawings show aspects of one or more of the embodiments as described herein. However, it should be understood that the present disclosure is not limited to the precise arrangements and instrumentalities shown in the drawings, wherein:

FIG. 1 is a diagram of a building and components of an indoor wireless network;

FIG. 2 is a flow chart of a method of obtaining and deriving cryptographic keys for gaining access to a local network;

FIG. 3 shows indoor devices separated into functional groups;

FIG. 4 is a flow chart of a method of obtaining and deriving cryptographic keys for gaining access to a local network;

FIG. 5 is a schematic illustration of major components of an example of an indoor device;

FIG. 6 is a schematic illustration of major components of an example of a commissioning device; and

FIG. 7 is a diagrammatic representation of one example of a computing device that may be used to implement aspects of the present disclosure.

### DETAILED DESCRIPTION

Aspects of the present disclosure include methods and systems for commissioning and authenticating devices for joining a local network that improve the security of the network and make it more difficult for unauthorized devices to gain access to the network. In some examples, communication channels that have a more limited range and/or direction as compared to RF communication are employed for exchanging information used to join the network, such as cryptographic keys. In some examples, techniques for deriving temporary and/or dynamic keys are disclosed.

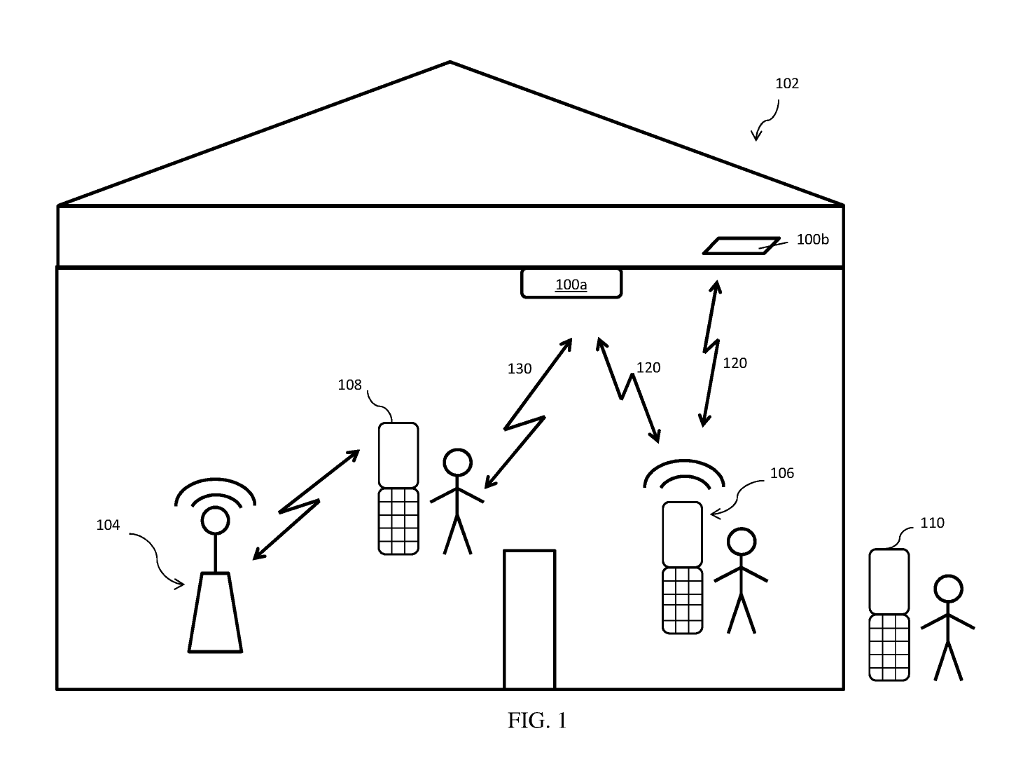

FIG. 1 illustrates one example including multiple fixed indoor devices 100 within a building 102 that are configured to communicate over an indoor wireless network that includes an access point 104, such as a router or gateway. In other examples, one or more of indoor devices 100 could be connected over a wired network. FIG. 1 also illustrates a commissioning device 106 for commissioning indoor devices 100 to the network, a mobile device 108 that requests access to the wireless network, and an attacker device 110 that wishes to gain unauthorized access to the network. In the illustrated example, indoor devices 100 include a luminaire 100a and a water leak sensor 100b. In other examples, the methods disclosed herein can be applied to any kind of device configured to communicate over a wired or wireless network, such as a variety of components utilized in building infrastructure systems such as networked lighting and associated switches and light sensors, door locks, security cameras, presence sensors, heating, ventilation and air conditioning (HVAC) system components and controls, such as thermostats, etc. Suitable network protocols for the indoor wireless network of devices 100 include, for example, Digital Address Line Interface (DALI), ZigBee, Dynet, Starsense, Thread, Ethernet and Wi-Fi®.

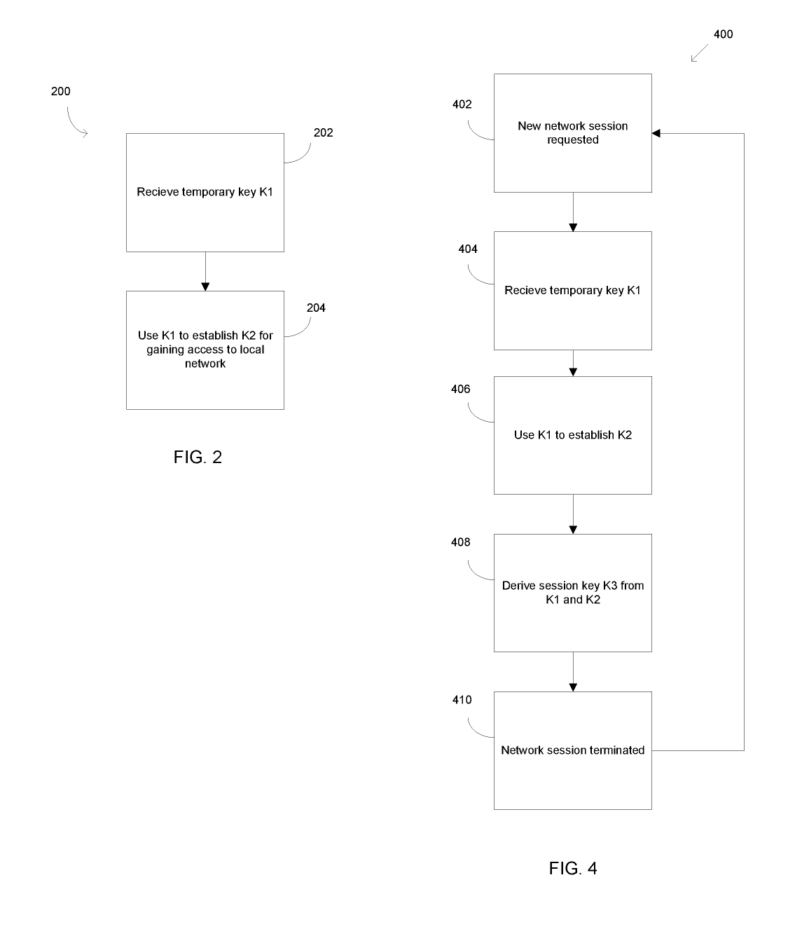

The process of connecting indoor devices 100 to a local network is typically referred to as “commissioning” and, in the illustrated example, involves a process in which commissioning device 106 exchanges information with the indoor devices 100 via signals 120 in order to add the indoor devices to a local wireless network. FIG. 2 shows one example process 200, in which an indoor device is provided a secure static key for accessing the network. At step 202, one of the indoor devices 100 may receive information from the commissioning device 106 for commissioning the indoor device to the network. The information provided may include configuration messages and at least one key, K1. As described below, in one example, K1 is transmitted via an out-of-band communication channel. For example, K1 may be transmitted acoustically or optically rather than via RF waves. At step 204, the indoor device 100 may use the key K1 to derive relevant network and link keys K2 for authenticating the indoor device to the network and for encrypting messages exchanged with the indoor wireless network. Any of a variety of algorithms may be used for deriving K2, for example, challenge-response authentication algorithms, such as the Challenge-Handshake Authentication Protocol or Salted Challenge Response Authentication Mechanism, as well as public key protocols, such as Diffie-Hellman, ElGamal, Elliptic Curves, RSA, etc.

Such a process employs a unidirectional configuration in which information is provided from commissioning device 106 to the indoor devices 100. In another example, a bidirectional configuration may be used, in which commissioning device 106 initiates the commissioning process of indoor device 100 and, subsequently, each corresponding respective indoor device responds with, for example, an acknowledgement to the commissioning device.

Unlike prior art commissioning devices that communicate with indoor devices via RF signals, in the illustrated example, signals 120 may be acoustic wave signals. Any of a variety of acoustic communication techniques can be used, including wave frequencies audible to humans, ultrasound, and infrasound. Different wave frequencies can provide various useful features. For example, one benefit of audible sound waves would be the ability to provide audible feedback to a person commissioning the indoor device 100. One advantage of using an acoustic signal for communication of signals 120 is that direct line-of-sight is not required, such that indoor devices 100 can be installed and out of view during commissioning, such as behind a wall or ceiling tile. For example, in the illustrated embodiment, while luminaire 100a is in view of commissioning device, water leak sensor 100b may be out of view, e.g., behind a ceiling tile. Another benefit is acoustic waves can also have a limited range as compared to RF signals, making forging and eavesdropping by devices outside of building 102, such as attacker device 110, difficult. Acoustic waves can, therefore, provide a trusted communication channel for communicating with targeted indoor device(s) 100.

In another example, signals 120 may be optical signals. Any frequency of optical signal can be employed, including, for example, any frequency in the visible or infrared range. Unlike acoustic signals, some forms of optical communication may use line of sight between the commissioning device 106 and indoor devices 100. Other forms, however, such as infrared in diffused mode could enable communication without direct line of sight, e.g., via reflections. As with acoustic communication, a benefit of optical communication is the directionality and range of an optical communication is much more limited than RF, making it more difficult for an unauthorized device located outside of building 102, such as attacker device 110, to intercept the communication and gain unauthorized access to the network.

In yet another example, indoor devices 100 may be equipped with one or more of a bar code, QR code, radio frequency identification (RFID) tag or Near Field Communication (NFC) chip. In the case of a RFID or NFC tag or chip, commissioning device 106 may include a reader configured to activate the tag or chip connected to the indoor device 100. Commissioning device 106 may accept directed signals from the tag or chip that are received within a predefined duration. Since RFID or NFC are short distance RF-based communication technologies, the commissioning device 106 could read an ID of indoor devices 100 and then provide or write a secret key K1 into such indoor device, such that the indoor device can be authenticated to the network.

Commissioning device 106 can also be configured to collect location information that can be used to create a map of commissioned indoor devices 100 within building 102. For example, commissioning device 106 can be equipped with directional acoustic receivers that can detect a direction from which an indoor device 100 has responded to an acoustic signal. Such directional information can be used to develop a map of indoor device locations. Similarly, in the case of optical communication, commissioning device 106 may be equipped with photodetectors that can be used to collect location information from indoor devices 100 to create a map of commissioned indoor devices within building 102. In one example, commissioning device 106 can either have an automatic indoor positioning system that identifies the location of the commissioning device within building 102, or a position of the commissioning device 106 can be manually entered by a user.

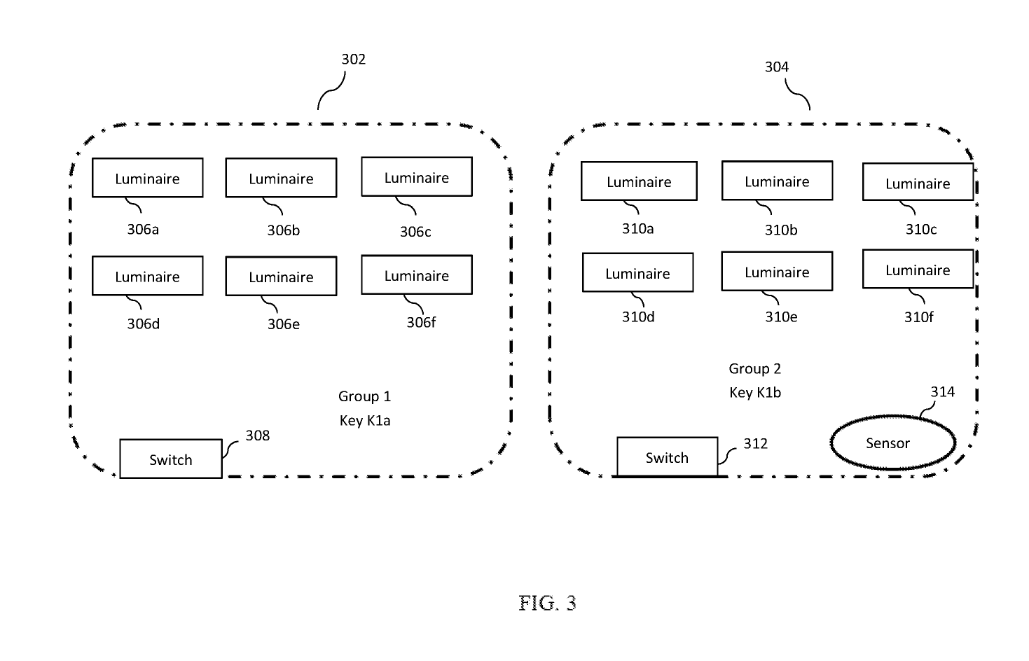

Commissioning device 106 can also be configured to send function-based or location-based temporary keys K1. FIG. 3 illustrates one example in which the temporary keys K1 are used to assign indoor devices to functional groups. FIG. 3 shows a first functional group 302 and a second functional group 304. Commissioning device 106 can provide a first temporary key K1a to the first group 302 of indoor devices, including luminaires 306a-f and luminaire switch 308, and provide a second temporary key K1b to the second group 304 of indoor devices, including luminaires 310a-f, luminaire switch 312 and light sensor 314. By providing functional-group specific temporary keys K1a,b, when the indoor devices in the first group 302 use their key K1a to initiate communication with the indoor network, such identifying information can be used by the network to assign each of the indoor devices to the same functional group such that, for example, switch 308 controls all of luminaires 306a-f but not luminaires 310a-f. Second functional group 304 of indoor devices can similarly be assigned by the indoor network to a second group when they use K1b to join the network.

Referring again to FIG. 1, once indoor devices 100 are commissioned to the indoor network, one or more of the indoor devices may also be configured to communicate with mobile device 108 to authenticate the mobile device to the indoor network. For example a user may wish to gain access to the indoor network via mobile device 108 to, for example, obtain Wi-Fi® internet access, or send commands and/or monitor the status of connected indoor devices 100, such as door locks, security cameras, presence sensors, thermostats, luminaires, etc. In such circumstances, it may be desirable to verify the identity of mobile device 108 and restrict access to mobile devices within building 102. In the illustrated example, mobile device 108 can exchange information with indoor device 100a via optical signals 130 which, as described above, can be more secure than RF communication. In one example, one or more luminaires 100a may be configured to communicate with mobile device 108 to provide authentication via optical signals 130, while in other examples, other kinds of indoor devices in addition to, or instead of luminaires may be used. Luminaires provide the benefit of easy direct line of sight for optical communication in one or more rooms of building 102. In other examples, acoustic rather than optical communication between a mobile device 108 and one or more indoor devices 100 may be used.

In one example, indoor device 100a and mobile device 108 can follow the same process for securely establishing a static key that was described above and illustrated in FIG. 2. Referring again to FIG. 2, at step 202, the mobile device 108 may receive information that includes at least one key K1 from the now-commissioned indoor device 100a optically, or in other examples acoustically. At step 204, the mobile device 108 can use key K1 to derive relevant network and link keys K2 for authenticating the mobile device 108 to the network and for encrypting messages exchanged with the indoor wireless network. Any of a variety of algorithms may be used for deriving K2, for example, challenge-response authentication algorithms, such as the Challenge-Handshake Authentication Protocol or Salted Challenge Response Authentication Mechanism, as well as public key protocols, such as Diffie-Hellman, ElGamal, Elliptic Curves, RSA, etc.

FIG. 4 illustrates another example key exchange process 400 for authenticating the mobile device 108 that includes the use of a dynamic session key rather than the static key K2 described in connection with FIG. 2. As shown, the mobile device 108 may follow process 400 each time it requests a new network session, and at step 402, a new network session is requested. Steps 404 and 406 are similar to process 200—at step 404, the mobile device 108 may receive information that includes at least one temporary key, K1 from the indoor device 100a, provided either optically or acoustically. At step 406, the mobile device 108 may use key K1 to derive K2 for authenticating the mobile device to the network. At step 408, both mobile device 108 and an entity in the indoor network can then use both K1 and K2 to derive a temporary session key K3 for encrypting messages exchanged over the network. In one example, an exclusive OR (XOR) operation between K1 and K2 may be used to derive K3, i.e., K3=K1⊕K2. Any of a variety of other algorithms for transforming keys may also be used, for example a hash function of K1 concatenated to K2 may be used to derive K3. In another example, K2 may be a dynamic key that is periodically derived, e.g., for each new session and that can be used for both authenticating mobile device 108 to the network and for communicating over the network rather than deriving a third dynamic key K3.

As described above in connection with commissioning, functional or location information can be included in temporary key K1. If such functional or location information is associated with K1 provided to mobile device 108, such information can also be associated with K3. For example, the key K1 provided to mobile device 108 can provide identifying information associated with the particular indoor device 100 that provided K1, such as one or more of ID, device type, and/or physical location information associated with the indoor device. Such information may be useful in identifying unauthorized access by an attacker device 110. For example, the location of the unauthorized attacker device 110 at the time of authentication and the particular indoor device that provided K1, which may be compromised, can quickly be determined. If attacker device 110 temporarily gains access to building 102 such that it is able to obtain key K1 via an optical or acoustic signal from one of indoor devices 100, then it is easy to identify which indoor device 100 authenticated the attacker device 110. At step 410, mobile device 108 may terminate the network session. If the mobile device 108 once again requests access to the wireless network, the previously established session key K3 does not work and the process is repeated, beginning at step 402, to obtain a new session key K3.

In one or more of the unidirectional or bidirectional commissioning processes, and the static or dynamic key mobile device authentication processes, the first key K1 can be temporary, randomly-generated, and coordinated by the indoor network. In the case of commissioning, commissioning device 106 and a relevant entity in the wireless network, such as access point 104, can have an agreed-upon temporary key K1 that can be used to derive a network key K2 that the access point 104 accepts for a limited period of time for gaining network access. Key K1 can be directly communicated between commissioning device 106 and access point 104 over a secure wireless connection, a wired medium (such as powerline communication), or via an acoustic or optical channel. Alternatively, another signal may be communicated between the network and commissioning device 106 that can be used by each of the commissioning device 106 and a relevant network entity to derive K1. For example, a counter and linear feedback shift register (LFSR) approach can be used. A similar coordination of temporary key K1 can be accomplished between the network and one or more of commissioned indoor devices 100 configured to authenticate other devices such as mobile device 108. In one example, local commissioned indoor devices 100 can be configured to change temporary key K1 based on a pre-specified function that is agreed upon between the indoor devices and a relevant entity in the indoor network, such as access point 104. The commissioned local indoor devices 100 can be configured to change K1, for example, after a pre-specified time duration, or based on a request from access point 104.

For communication between a commissioned indoor device 100 and the other components in the indoor network, and for communications between an authenticated mobile device 108 and the network, either key K2, or in the case of dynamic session key for authenticating a mobile device, K3, can also be used in deriving hash functions for integrity checks, which can provide stronger authentication and privacy protection. For example, key K2 or K3 may be used as a seed for hash functions used for integrity checks.

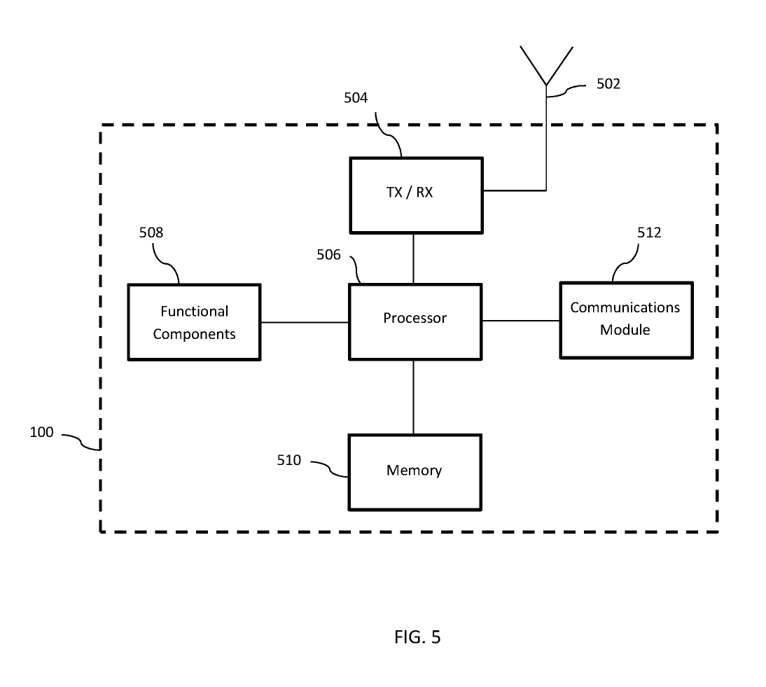

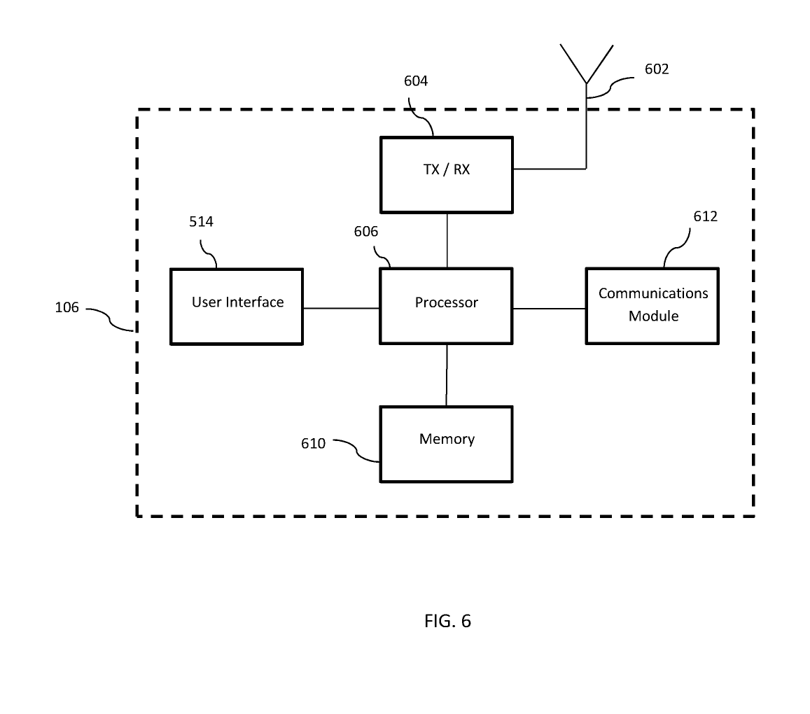

FIGS. 5 and 6 are schematic illustrations of major components of example embodiments of indoor device 100 (FIG. 5) and commissioning device 106 (FIG. 6). Referring to FIG. 5, as previously mentioned, each indoor device 100 may be connected in a network using any suitable networking protocol and by way of example, the arrangement shown in FIG. 5 is configured to be connected in a wireless protocol and the use of ZigBee will be described by way of example herein. The network could, however, be hard wired instead of being a wireless network. As shown in FIG. 5, indoor device 100 includes an RF communications module that includes an antenna 502 coupled to a ZigBee transceiver unit 504 which is coupled to a processor 506 that controls functional components 508 of the indoor device. As will be appreciated, functional components 508 may vary depending on the specific nature of the indoor device, such as, in the case of a luminaire, a switch and at least one light emitting element. Indoor device 100 may also include a memory 510 for storing, for example, a unique identifier, a network address, one or more keys for accessing and communicating on the network, etc. Indoor device 100 may also include an optical and/or acoustic communications module 512, which may include an optical and/or acoustic transducer or transceiver for communicating information with another device, such as commissioning device 106 or mobile device 108 (FIG. 1). Example optical transceiver units may include, for example, one or more of photodiodes, photoresistors, phototransistors, photomultipliers, photodetectors, image sensors, and any of a variety of light emitting elements, such as one or more light emitting diodes. Example acoustic transceiver units may include, for example, one or more of speakers, microphones, tactile transducers, piezoelectric crystals, and ultrasonic transceivers. In one example, one or more indoor devices 100 may include both optical and acoustic transceiver units, such that the indoor device can receive, and in some cases, also send acoustic signals from and to commissioning device 106 and can send and receive optical communications with mobile device 108 that wishes to access the local network.

Referring to FIG. 6, commissioning device 106 may be configured to communicate with an indoor wireless network using any suitable networking protocol. In the illustrated example, commissioning device 106 includes an RF communications module that includes an antenna 602 coupled to a ZigBee transceiver unit 604 which is coupled to a processor 606. Commissioning device 106 can also include a memory 610 for storing, for example, unique ID, current indoor position, private keys, and a database of the commissioned devices, with their location and timestamp, among other things. Commissioning device 106 may also include an optical and/or acoustic communications module 612 that may include an optical and/or acoustic transducer or transceiver for communicating information with another device, such as indoor devices 100 (FIG. 1) and can include one or more of the components listed above in connection with the indoor device optical and/or acoustic transducer or transceiver of communications module 512 (FIG. 5). Commissioning device 106 can also include a user interface 614 for operating the commissioning device 106. Commissioning device 106 may be implemented in a variety of ways including, for example, a hand-held device that is configured for transport throughout a building such as building 102 for commissioning an indoor device 100 in one or more locations within the building. Commissioning device 106 may also be a mobile device that is configured to be temporarily located in a specific region of a building for commissioning. For example, a plurality of commissioning devices may be located throughout a building and may be remotely controlled, e.g., over a local wired or wireless network, for commissioning indoor devices 100 as the indoor devices are installed. In yet another example, commissioning device 106 may be an autonomous vehicle that may be used, for example, for automatic system commissioning.

Any one or more of the aspects and embodiments described herein may be conveniently implemented using one or more machines (e.g., one or more computing devices that are utilized as a user computing device for an electronic document, one or more server devices, such as a document server, etc.) programmed according to the teachings of the present specification, as will be apparent to those of ordinary skill in the computer art. Appropriate software coding can readily be prepared by skilled programmers based on the teachings of the present disclosure, as will be apparent to those of ordinary skill in the software art. Aspects and implementations discussed above employing software and/or software modules may also include appropriate hardware for assisting in the implementation of the machine executable instructions of the software and/or software module.

Such software may be a computer program product that employs a machine-readable storage medium. A machine-readable storage medium may be any medium that is capable of storing and/or encoding a sequence of instructions for execution by a machine (e.g., a computing device) and that causes the machine to perform any one of the methodologies and/or embodiments described herein. Examples of a machine-readable storage medium include, but are not limited to, a magnetic disk, an optical disc (e.g., CD, CD-R, DVD, DVD-R, etc.), a magneto-optical disk, a read-only memory “ROM” device, a random access memory “RAM” device, a magnetic card, an optical card, a solid-state memory device, an EPROM, an EEPROM, and any combinations thereof. A machine-readable medium, as used herein, is intended to include a single medium as well as a collection of physically separate media, such as, for example, a collection of compact discs or one or more hard disk drives in combination with a computer memory. As used herein, a machine-readable storage medium does not include transitory forms of signal transmission.

Such software may also include information (e.g., data) carried as a data signal on a data carrier, such as a carrier wave. For example, machine-executable information may be included as a data-carrying signal embodied in a data carrier in which the signal encodes a sequence of instruction, or portion thereof, for execution by a machine (e.g., a computing device) and any related information (e.g., data structures and data) that causes the machine to perform any one of the methodologies and/or embodiments described herein.

Examples of a computing device include, but are not limited to, an electronic book reading device, a computer workstation, a terminal computer, a server computer, a handheld device (e.g., a tablet computer, a smartphone, etc.), a smart watch or other wearable computing device, a web appliance, a network router, a network switch, a network bridge, any machine capable of executing a sequence of instructions that specify an action to be taken by that machine, and any combinations thereof. In one example, a computing device may include and/or be included in a kiosk.

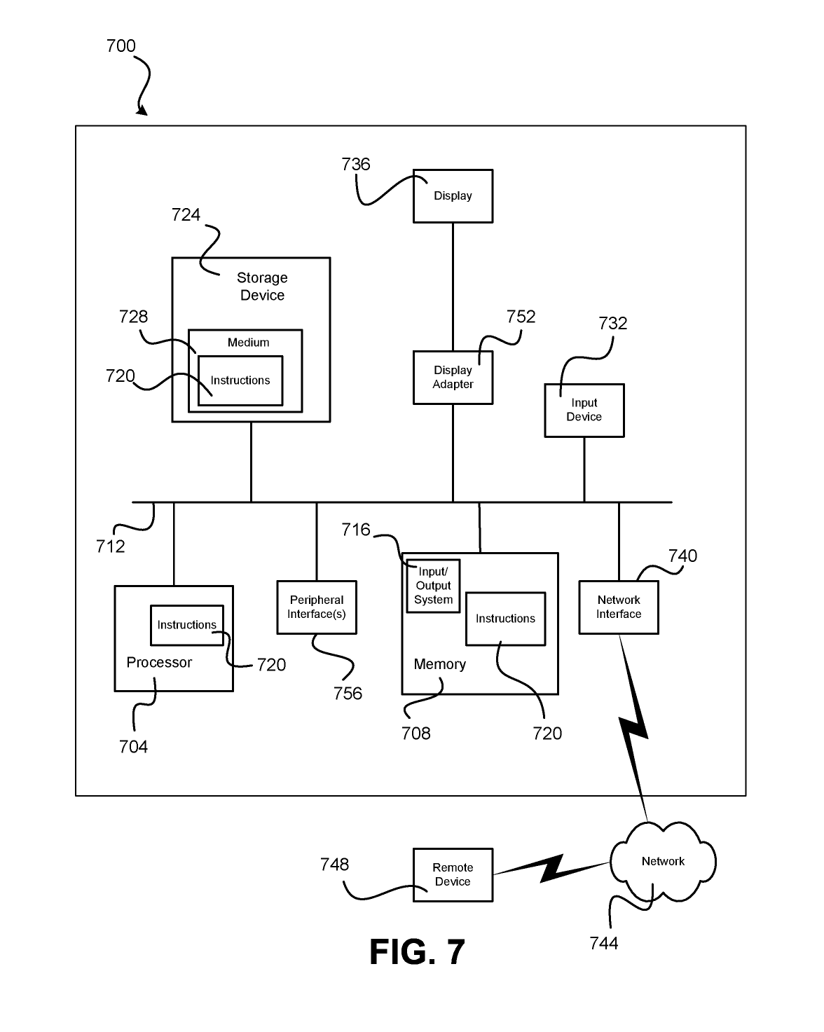

FIG. 7 shows a diagrammatic representation of one example embodiment of a computing device in the form of a computer system 700 within which a set of instructions for causing a system, such as the components illustrated in FIGS. 1, 3, 5, and 6, to perform any one or more of the aspects and/or methodologies of the present disclosure, including the methods illustrated in FIGS. 2 and 4, may be executed. It is also contemplated that multiple computing devices may be utilized to implement a specially configured set of instructions for causing one or more of the devices to perform any one or more of the aspects and/or methodologies of the present disclosure. Computer system 700 includes a processor 704 and a memory 708 that communicate with each other, and with other components, via a bus 712. Bus 712 may include any of several types of bus structures including, but not limited to, a memory bus, a memory controller, a peripheral bus, a local bus, and any combinations thereof, using any of a variety of bus architectures.

Memory 708 may include various components (e.g., machine-readable media) including, but not limited to, a random access memory component, a read only component, and any combinations thereof. In one example, a basic input/output system 716 (BIOS), including basic routines that help to transfer information between elements within computer system 700, such as during start-up, may be stored in memory 708. Memory 708 may also include (e.g., stored on one or more machine-readable media) instructions (e.g., software) 720 embodying any one or more of the aspects and/or methodologies of the present disclosure. In another example, memory 708 may further include any number of program modules including, but not limited to, an operating system, one or more application programs, other program modules, program data, and any combinations thereof.

Computer system 700 may also include a storage device 724. Examples of a storage device (e.g., storage device 724) include, but are not limited to, a hard disk drive, a magnetic disk drive, an optical disc drive in combination with an optical medium, a solid-state memory device, and any combinations thereof. Storage device 724 may be connected to bus 712 by an appropriate interface (not shown). Example interfaces include, but are not limited to, SCSI, advanced technology attachment (ATA), serial ATA, universal serial bus (USB), IEEE 1394 (FIREWIRE), and any combinations thereof. In one example, storage device 724 (or one or more components thereof) may be removably interfaced with computer system 700 (e.g., via an external port connector (not shown)). Particularly, storage device 724 and an associated machine-readable medium 728 may provide nonvolatile and/or volatile storage of machine-readable instructions, data structures, program modules, and/or other data for computer system 700. In one example, software 720 may reside, completely or partially, within machine-readable medium 728. In another example, software 720 may reside, completely or partially, within processor 704.

Computer system 700 may also include an input device 732. In one example, a user of computer system 700 may enter commands and/or other information into computer system 700 via input device 732. Examples of an input device 732 include, but are not limited to, an alpha-numeric input device (e.g., a keyboard), a pointing device, a joystick, a gamepad, an audio input device (e.g., a microphone, a voice response system, etc.), a cursor control device (e.g., a mouse), a touchpad, an optical scanner, a video capture device (e.g., a still camera, a video camera), a touchscreen, and any combinations thereof. Input device 732 may be interfaced to bus 712 via any of a variety of interfaces (not shown) including, but not limited to, a serial interface, a parallel interface, a game port, a USB interface, a FIREWIRE interface, a direct interface to bus 712, and any combinations thereof. Input device 732 may include a touch screen interface that may be a part of or separate from display 736, discussed further below. Input device 732 may be utilized as a user selection device for selecting one or more graphical representations in a graphical interface as described above.

A user may also input commands and/or other information to computer system 700 via storage device 724 (e.g., a removable disk drive, a flash drive, etc.) and/or network interface device 740. A network interface device, such as network interface device 740, may be utilized for connecting computer system 700 to one or more of a variety of networks, such as network 744, and one or more remote devices 748 connected thereto. Examples of a network interface device include, but are not limited to, a network interface card (e.g., a mobile network interface card, a LAN card), a modem, and any combination thereof. Examples of a network include, but are not limited to, a wide area network (e.g., the Internet, an enterprise network), a local area network (e.g., a network associated with an office, a building, a campus or other relatively small geographic space), a telephone network, a data network associated with a telephone/voice provider (e.g., a mobile communications provider data and/or voice network), a direct connection between two computing devices, and any combinations thereof. A network, such as network 744, may employ a wired and/or a wireless mode of communication. In general, any network topology may be used. Information (e.g., data, software 720, etc.) may be communicated to and/or from computer system 700 via network interface device 740.

Computer system 700 may further include a video display adapter 752 for communicating a displayable image to a display device, such as display device 736. Examples of a display device include, but are not limited to, a liquid crystal display (LCD), a cathode ray tube (CRT), a plasma display, a light emitting diode (LED) display, and any combinations thereof. Display adapter 752 and display device 736 may be utilized in combination with processor 704 to provide graphical representations of aspects of the present disclosure. In addition to a display device, computer system 700 may include one or more other peripheral output devices including, but not limited to, an audio speaker, a printer, and any combinations thereof. Such peripheral output devices may be connected to bus 712 via a peripheral interface 756. Examples of a peripheral interface include, but are not limited to, a serial port, a USB connection, a FIREWIRE connection, a parallel connection, and any combinations thereof.

The foregoing has been a detailed description of illustrative embodiments of the disclosure. It is noted that in the present specification and claims appended hereto, conjunctive language such as is used in the phrases “at least one of X, Y and Z” and “one or more of X, Y, and Z,” unless specifically stated or indicated otherwise, shall be taken to mean that each item in the conjunctive list can be present in any number exclusive of every other item in the list or in any number in combination with any or all other item(s) in the conjunctive list, each of which may also be present in any number. Applying this general rule, the conjunctive phrases in the foregoing examples in which the conjunctive list consists of X, Y, and Z shall each encompass: one or more of X; one or more of Y; one or more of Z; one or more of X and one or more of Y; one or more of Y and one or more of Z; one or more of X and one or more of Z; and one or more of X, one or more of Y and one or more of Z.

Various modifications and additions can be made without departing from the spirit and scope of this disclosure. Features of each of the various embodiments described above may be combined with features of other described embodiments as appropriate in order to provide a multiplicity of feature combinations in associated new embodiments. Furthermore, while the foregoing describes a number of separate embodiments, what has been described herein is merely illustrative of the application of the principles of the present disclosure. Additionally, although particular methods herein may be illustrated and/or described as being performed in a specific order, the ordering is highly variable within ordinary skill to achieve aspects of the present disclosure. Accordingly, this description is meant to be taken by way of example, and not to otherwise limit the scope of this disclosure.

Example embodiments have been disclosed above and illustrated in the accompanying drawings. It will be understood by those skilled in the art that various changes, omissions and additions may be made to that which is specifically disclosed herein without departing from the spirit and scope of the present disclosure.

What is claimed is:

1. A method of commissioning an indoor device with a commissioning device for adding the indoor device to a wireless network, comprising:
receiving, at the indoor device, an optical or acoustic signal from the commissioning device, wherein the optical or acoustic signal contains a first message; and
using, by the indoor device, information in the first message to join the wireless network.

2. The method of claim 1, further comprising:
in response to receiving the first message, transmitting from the indoor device an optical or acoustic signal to the commissioning device, wherein the optical or acoustic signal from the indoor device contains a second message.

3. The method of claim 2, wherein the second message includes an acknowledgement message and an identifier associated with the indoor device.

4. The method of claim 2, wherein the commissioning device determines a location of the indoor device using a directional receiver that receives the second message.

5. The method of claim 1, wherein the first message includes at least one of location information and functional group information, the location information and functional group information used by the commissioning device to group the indoor device with other indoor devices receiving the same first message.

6. The method of claim 1, wherein the first message includes a first key, the method further comprising:
deriving, by the indoor device, a second key from the first key, the second key used to authenticate the indoor device with the wireless network.

7. The method of claim 6, further comprising:
changing, by the indoor device, the first key based on one of an expiry of a time period and a request from an access point in the wireless network.

8. The method of claim 1, wherein the first message includes a first key, the method further comprising:
transmitting, by the indoor device, the first key via an optical or acoustic signal to a mobile device requesting access to the wireless network; and
receiving, from the mobile device, a second key derived from the first key via an optical or acoustic signal, the second key used to authenticate the mobile device with the wireless network.

9. The method of claim 8, further comprising:
deriving, by the indoor device, a dynamic session key from the first key and the second key;
transmitting, by the indoor device, the dynamic session key to the mobile device, wherein the mobile device uses the dynamic session key to encrypt messages transmitted over the wireless network.

10. The method of claim 9, wherein the dynamic session key expires after a network session of the mobile device terminates.

11. The method of claim 8, further comprising receiving, from the mobile device, a privacy or integrity check with a cryptographic hash function and a dynamic session key derived from the first key and the second key.

12. The method of claim 8, the method further comprising transmitting, by the indoor device, at least one of location, function, or identifying information associated with the indoor device to the mobile device.

13. The method of claim 1, wherein the indoor device is a luminaire.

14. An indoor device, comprising:
an RF communications module for communication over a wireless network; and
at least one of an optical or acoustic communications module for receiving an optical or acoustic signal from a commissioning device, the optical or acoustic signal including information for joining the wireless network, the information including a first key.

15. The indoor device of claim 14, further comprising a processor that is configured to perform operations comprising:
deriving a second key from the first key, the second key used by the indoor device to authenticate with the wireless network.

16. The indoor device of claim 14, wherein the optical or acoustic communications module is further configured to send and receive optical or acoustic signals to and from a mobile device for authenticating the mobile device to the wireless network.

17. The indoor device of claim 16, wherein the processor is further configured to perform operations comprising:
transmitting the first key via an optical or acoustic signal to the mobile device, wherein the mobile device derives a second key from the first key, the second key used by the mobile device to authenticate with the wireless network.

18. The indoor device of claim 16, wherein the processor is further configured to perform operations comprising:
transmitting the first key via an optical or acoustic signal to the mobile device;
receiving, from the mobile device, a second key via an optical or acoustic signal, the second key derived from the first key; and
deriving a dynamic key from the first key and the second key, the dynamic key used by the mobile device to encrypt messages over the wireless network.

19. A system, comprising:
a commissioning device configured to:
transmit a first message to one or more indoor devices through an optical or acoustic signal, the first message including a first key; and
one or more indoor devices, each indoor device configured to:
receive the first message via an optical or acoustic transceiver;
derive a second key from the first key, the second key used to authenticate the indoor device with a wireless network;
transmit the second key to an access point of the wireless network; and
transmit the first key to a mobile device requesting access to the wireless network via an optical or acoustic signal; and
the access point, wherein the access point is configured to:
provide the first key to the commissioning device;
authenticate the one or more indoor devices to the wireless network upon receipt of the second key from each of the one or more indoor devices;
authenticate the mobile device to the wireless network upon receipt of the second key from the mobile device.

20. The system of claim 19, wherein the access point is further configured to:
determine a dynamic key based on the first key and the second key, the dynamic key used by the mobile device to encrypt messages over the wireless network.
